(19) United States
(12) Patent Application Publication
(10) Pub. No.: US 2025/0239105 A1
(43) Pub. Date: Jul. 24, 2025

(54) ON-SITE SIGNATURE PROCESS VERIFICATION SYSTEM AND VERIFICATION METHOD

(71) Applicant: Hangzhou Kind Supply Creation Co., Ltd., Hangzhou (CN)

(72) Inventors: Xiaojun Zhu, Hangzhou (CN); Yanhua Li, Hangzhou (CN)

(21) Appl. No.: 19/031,118

(22) Filed: Jan. 17, 2025

(30) Foreign Application Priority Data
Jan. 22, 2024 (CN) 202410087624.5

(51) Int. Cl. G06V 40/30; G06V 10/10; G06V 40/16; G06V 40/70

(52) U.S. Cl. CPC G06V 40/33; G06V 10/17; G06V 40/172; G06V 40/70

(57) ABSTRACT

The present invention relates to an on-site signature process verification system and verification method. In this system, a first camera of an intelligent signature pen obtains a first image information of the image at the signing position, and a second camera of the intelligent signature pen obtains a second image information of the signing environment image. The intelligent signature pen sends the first image information and the second image information to an intelligent mobile terminal. The intelligent mobile terminal uploads the first image information and the second image information to a cloud server. A verification terminal obtains and displays the first image information and the second image information for verification from the cloud server. The present invention uses an intelligent signature pen to achieve a full record of the signature process, which can reduce labor and hardware costs and improve business efficiency.

### CROSS REFERENCE TO RELATED APPLICATIONS

The present application claims the benefit of Chinese Patent Application No. 2024100876245 filed on Jan. 22, 2024, the contents of which are incorporated herein by reference in their entirety.

### TECHNICAL FIELD

The present invention relates to the field of signature process recording, and more specifically, to an on-site signature process verification system and verification method.

### DESCRIPTION OF RELATED ART

The signature process is of great legal significance. However, it is very difficult to prove the authenticity of a signature. In the prior art, verification is usually carried out for certain occasions through handwriting identification, but handwriting can still be easily imitated with the existing technology. In some more important occasions, such as bank loans or notarization, on-site video recording is required for backup so as to check the authenticity of the signature. Nevertheless, on-site video recording usually requires taking professional video equipment to the client's site for recording, which leads to high labor costs and camera costs as well as low efficiency.

### BRIEF SUMMARY OF THE INVENTION

### Technical Problem

The technical problem to be solved by the present invention lies in providing an on-site signature process verification system and verification method.

### Technical Solutions

The technical solution adopted by the present invention to solve its technical problems is as follows: An on-site signature process verification system is constructed, which is comprising an intelligent signature pen, an intelligent mobile terminal, a cloud server and a verification terminal. The intelligent signature pen is connected to the intelligent mobile terminal through short-distance wireless communication, the intelligent mobile terminal is connected to the cloud server through a mobile network, and the verification terminal is communicatively connected to the cloud server.

The intelligent signature pen includes a first camera located on the pen body and a second camera located on the pen cap. The first camera is used for obtaining a first image information of the image at the signing position, and the second camera is used for obtaining a second image information of the signing environment image. The intelligent signature pen sends the first image information and the second image information to the intelligent mobile terminal. The intelligent mobile terminal displays the image information during the signing process in real time and uploads the first image information and the second image information to the cloud server after receiving the completion instruction.

The verification terminal obtains the first image information and the second image information from the cloud server, and the verification terminal displays the first image information and the second image information for verification.

Furthermore, in the on-site signature process verification system of the present invention, the second camera is detachably mounted on the intelligent signature pen, and the second camera is connected to the intelligent signature pen through short-distance wireless communication.

Furthermore, in the on-site signature process verification system of the present invention, the intelligent signature pen also includes a WiFi module, and the intelligent signature pen uploads the first image information and the second image information to the cloud server through the WiFi module.

Furthermore, in the on-site signature process verification system of the present invention, the intelligent signature pen also includes a control button for controlling the working states of the first camera and the second camera.

Furthermore, in the on-site signature process verification system of the present invention, the intelligent mobile terminal is installed with an application program used for verifying the user's identity. The application program conducts face recognition verification on the current user by calling the camera of the intelligent mobile terminal.

In addition, the present invention also provides an on-site signature process verification method, comprising:

Step S1: a first camera of an intelligent signature pen obtains a first image information of the image at the signing position, and the second camera of the intelligent signature pen obtains a second image information of the signing environment image.

Step S2: the intelligent signature pen sends the first image information and the second image information to an intelligent mobile terminal.

Step S3: the intelligent mobile terminal uploads the first image information and the second image information to a cloud server.

Step S4: a verification terminal obtains the first image information and the second image information from the cloud server and displays them for verification.

Furthermore, in the on-site signature process verification method of the present invention, a step is further comprised before step S1:

Step S10: The camera of the intelligent mobile terminal obtains the face information of the current user and uploads the face information to the cloud server. The cloud server verifies whether the face information matches a registered face information to which the intelligent signature pen belongs.

If it matches, then execute step S1.

Furthermore, in the on-site signature process verification method of the present invention, the step S1 comprising:

After a control button of the intelligent signature pen sends a start recording instruction, the first camera obtains the first image information of the image at the signing position, and at the same time, the second camera obtains the second image information of the signing environment image.

After the control button sends a stop recording instruction, the first camera and the second camera stop recording.

Furthermore, in the on-site signature process verification method of the present invention, after the step S1, the following step is also comprised:

Step S5: The intelligent signature pen sends the first image information and the second image information to the cloud server through a WiFi module of the intelligent signature pen, and then executes the step S4.

Furthermore, in the on-site signature process verification method of the present invention, the step S2 further comprising:

After receiving the first image information and the second image information, the intelligent mobile terminal displays a corresponding signature record.

Implementing an on-site signature process verification system and verification method of the present invention has the following beneficial effects: the present invention uses an intelligent signature pen to achieve a full record of the signature process, which can reduce labor and hardware costs and improve business efficiency.

### BRIEF DESCRIPTION OF THE ACCOMPANYING DRAWINGS

The following will further illustrate the present invention in combination with the accompanying drawings and embodiments. In the accompanying drawings:

FIG. 1 is a schematic diagram of the on-site signature process verification system provided by the embodiment of the present invention.

FIG. 2 is a schematic diagram of the intelligent signature pen provided by the embodiment of the present invention

FIG. 3 is a schematic diagram of the intelligent signature pen provided by the embodiment of the present invention.

FIG. 4 is a schematic diagram of the on-site signature process verification system provided by the embodiment of the present invention.

FIG. 5 is a flowchart of the on-site signature process verification method provided by the embodiment of the present invention.

FIG. 6 is a flowchart of the on-site signature process verification method provided by the embodiment of the present invention.

FIG. 7 is a flowchart of the on-site signature process verification method provided by the embodiment of the present invention.

### DETAILED DESCRIPTION OF THE INVENTION

In order to have a clearer understanding of the technical features, purposes and effects of the present invention, the specific embodiments of the present invention will now be described in detail with reference to the accompanying drawings.

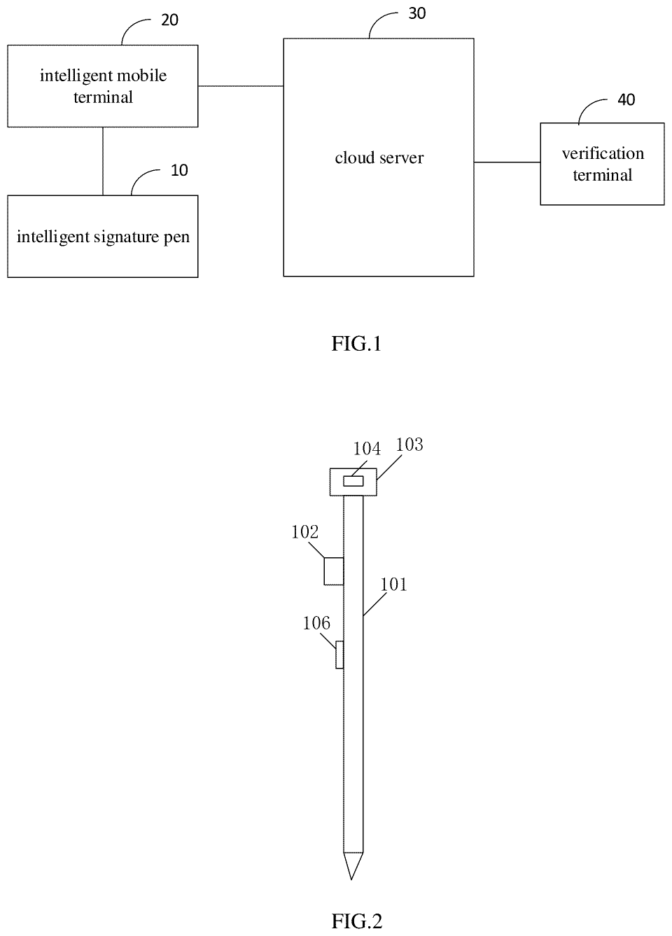

In a preferred embodiment, referring to FIG. 1 and FIG. 2, the embodiment provides an on-site signature process verification system. The on-site signature process verification system includes an intelligent signature pen 10, an intelligent mobile terminal 20, a cloud server 30 and a verification terminal 40. The intelligent signature pen 10 is connected to the intelligent mobile terminal 20 through short-range wireless communication. The intelligent mobile terminal 20 is connected to the cloud server 30 through a mobile network, and the verification terminal 40 is communicatively connected to the cloud server 30. Optionally, the intelligent signature pen 10 is connected to the intelligent mobile terminal 20 through Bluetooth communication, that is to say, both the intelligent signature pen 10 and the intelligent mobile terminal 20 include Bluetooth modules, and the intelligent signature pen 10 and the intelligent mobile terminal 20 establish a short-range wireless communication connection through the Bluetooth modules. Optionally, the verification terminal 40 can be a separate hardware device or a part of the functional modules of an intelligent terminal (such as a smartphone, a tablet computer). For example, by installing an application program on an intelligent terminal and the intelligent terminal can have the functions of the verification terminal 40.

Preferably, the intelligent mobile terminal 20 in this embodiment is a smartphone. It can be understood that since smartphones are equipped with Bluetooth modules by themselves, users do not need to re-equip the intelligent mobile terminal 20. They can use the technical solution of this embodiment by using their existing smartphones, thereby reducing the usage cost.

The intelligent signature pen 10 includes a first camera 102 located on the pen body 101. The shooting range of the first camera 102 is aligned with the nib part of the intelligent signature pen 10 and is used for obtaining the first image information of the image at the signature position. The image at the signature position refers to an image within a certain range that includes the position where the user signs, so the first image information includes the entire signature process of the user. Optionally, the first image information can be continuous video images or pictures at continuous intervals.

The intelligent signature pen 10 also includes a second camera 104 located on the pen cap 103. The shooting range of the second camera 104 covers the environment of the signature process and is used for obtaining the second image information of the signature environment image. The signature environment image refers to the surrounding environment information of the signature, such as the information about the signatory and the signing venue, etc. Therefore, the second image information includes the environmental information of the entire environment where the user signs. Optionally, the second image information can be continuous video images or pictures at continuous intervals.

In order to enable the second camera 104 to record more information about the signature environment, the second camera 104 is selected as a camera assembly composed of at least two cameras. Each camera of the camera assembly shoots environmental images from different angles respectively, and finally synthesizes a 360-degree environmental image around the intelligent signature pen 10. Alternatively, the second camera 104 is a 360-degree panoramic camera, which is used to directly shoot a 360-degree environmental image around the intelligent signature pen 10.

Furthermore, after obtaining the first image information and the second image information, the intelligent signature pen 10 sends the first image information and the second image information to the intelligent mobile terminal 20. The intelligent mobile terminal 20 displays the image information during the signature process in real time, that is, the intelligent mobile terminal 20 displays the first image information and the second image information in real time. After receiving the completion instruction, the intelligent mobile terminal 20 uploads the first image information and the second image information to the cloud server 30. The verification terminal 40 obtains the first image information and the second image information from the cloud server 30. The verification terminal 40 displays the first image information and the second image information for verification, and the verification personnel check whether the first image information and the second image information displayed on the verification terminal 40 are authentic. To facilitate the verification terminal 40 to find the required first image information and second image information on the cloud server 30, in this embodiment, when the intelligent signature pen 10 uploads the first image information and the second image information, the first image information and the second image information are named, for example, using the serial number of the intelligent signature pen 10 as the file name, or using the current time as the file name, or using the name of the user to whom the intelligent signature pen belongs as the file name, etc.

It can be understood that the intelligent signature pen 10 in this embodiment includes a battery, a power supply circuit and a control circuit. The battery and the power supply circuit supply power to the entire intelligent signature pen 10, and the control circuit is used to control and coordinate each module of the intelligent signature pen 10 to complete the corresponding functions. Optionally, the installation positions of the battery, the power supply circuit and the control circuit can be set flexibly. For example, the battery, the power supply circuit and the control circuit can all be arranged inside the pen body 101 of the intelligent signature pen 10, or they can all be arranged inside the pen cap 103, or the battery, the power supply circuit and the control circuit can be respectively arranged inside the pen body 101 and the pen cap 103.

In this embodiment, an intelligent signature pen is used to achieve a full record of the signature process, and the signature process can be automatically uploaded to the cloud, enabling remote verification operators to conduct remote verification operations. Compared with the existing technologies, there is no longer a need for complicated equipment and personnel. In this embodiment, only one intelligent signature pen is required, which can reduce labor and hardware costs and improve business efficiency.

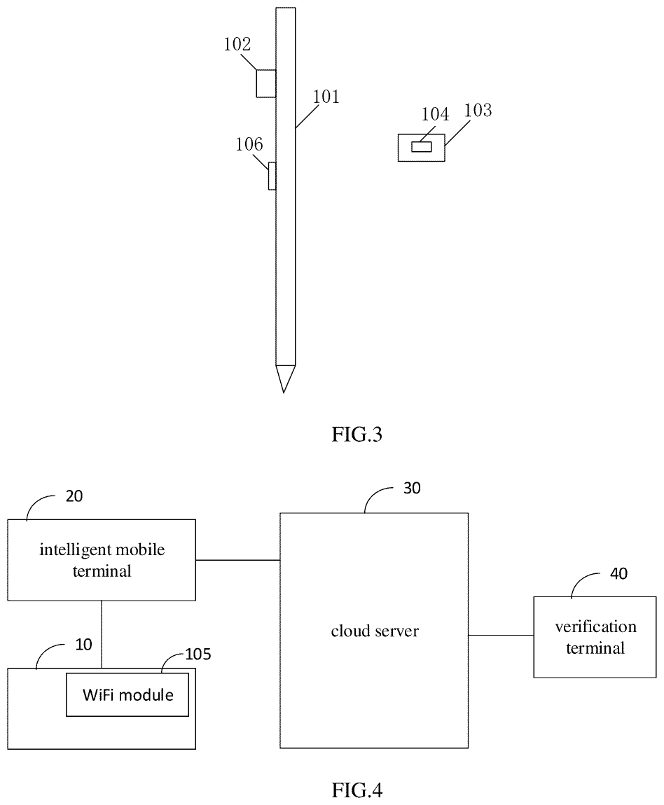

In the on-site signature process verification systems of some embodiments, referring to FIG. 3, in order to help users better record the environmental information of the signature process, in this embodiment, the second camera 104 is detachably installed on the intelligent signature pen 10. When the signature pen is not in use, the second camera 104 is installed on the signature pen 10 for easy carrying. Before signing, the user detaches the second camera 104 from the intelligent signature pen 10 and places it in an appropriate position as needed so that the environmental information of the signature process can be better recorded. Furthermore, since the second camera 104 still needs to exchange information with the pen body of the intelligent signature pen 10 after being detached from it, the second camera 104 is connected to the intelligent signature pen 10 through short-range wireless communication. For example, the second camera 104 is connected to the intelligent signature pen 10 through Bluetooth communication.

Optionally, the pen cap 103 where the second camera 104 is located can also be detachably installed on the intelligent signature pen 10 as a whole. When the intelligent signature pen 10 is not in use, the pen cap 103 is installed on the intelligent signature pen 10, which is convenient for carrying. Before signing, the user detaches the pen cap 103 as a whole and places it in an appropriate position as needed so that the environmental information of the signature process can be better recorded.

It can be understood that since the second camera 104 or the pen cap 103 is detachably installed on the intelligent signature pen 10, an independent battery and power supply circuit need to be set inside the second camera 104 or the pen cap 103. Of course, an independent battery and power supply circuit also need to be set inside the pen body 101.

In addition, since the second camera 104 or the pen cap 103 and the pen body 101 adopt a split design in this embodiment, the first image information obtained by the first camera 102 and the second image information obtained by the second camera 104 are separated accordingly. And both the first image information and the second image information need to be transmitted to the intelligent mobile terminal 20, which can be transmitted in the following three ways:

A first transmission method: The second camera 104 or the pen cap 103 transmits the second image information to the pen body 101 through short-range wireless communication, and then the pen body 101 transmits the first image information and the second image information to the intelligent mobile terminal 20 through short-range wireless communication.

A second transmission method: The pen body 101 transmits the first image information to the second camera 104 or the pen cap 103 through short-range wireless communication, and then the second camera 104 or the pen cap 103 transmits the first image information and the second image information to the intelligent mobile terminal 20 through short-range wireless communication.

A third transmission method: The pen body 101 transmits the first image information to the intelligent mobile terminal 20 through short-range wireless communication, and the second camera 104 or the pen cap 103 transmits the second image information to the intelligent mobile terminal 20 through short-range wireless communication.

In this embodiment, through the detachable design of the second camera 104, users can flexibly adjust the shooting angle and shooting range of the signature environment image as needed, so as to better record the signature process.

In the on-site signature process verification systems of some embodiments, referring to FIG. 3, the intelligent signature pen 10 also includes a control button 106 used to control the working states of the first camera 102 and the second camera 104. Before starting to sign, the user presses the control button 106. After the control button 106 of the intelligent signature pen 10 sends out a start recording instruction, the first camera 102 obtains the first image information of the image at the signature position, and at the same time, the second camera 104 obtains the second image information of the signature environment image. After the signature is completed, the user presses the control button 106 again. After the control button 106 sends out a stop recording instruction, the first camera 102 and the second camera 104 stop recording. In this embodiment, the user controls the start time and end time of recording the signature process through the control button 106, which is convenient for the user to control the recording progress by himself.

In the on-site signature process verification systems of some embodiments, referring to FIG. 4, in order to facilitate the intelligent signature pen 10 to upload the captured first image information and second image information to the cloud server 30, the intelligent signature pen 10 in this embodiment also includes a WiFi module 105. When the intelligent signature pen 10 detects that there is an available WiFi signal within its range, it automatically connects to the wireless router. If the wireless router is set with a password, the intelligent mobile terminal 20 can be used to assist the intelligent signature pen 10 to connect to the wireless router. After the intelligent signature pen 10 is connected to the wireless router, the intelligent signature pen 10 uploads the first image information and the second image information to the cloud server 30 through the WiFi module 105. In this embodiment, the intelligent signature pen 10 can directly upload the captured first image information and second image information to the cloud server 30 via the WiFi mode, which has a faster transmission rate and can also save the resources of the intelligent mobile terminal 20.

In the on-site signature process verification systems of some embodiments, an application program for verifying user identities is installed on the intelligent mobile terminal 20, and identity verification is required before the user uses the intelligent signature pen 10. The application program performs facial recognition verification on the current user by calling the camera of the intelligent mobile terminal 20. That is, the camera of the intelligent mobile terminal 20 obtains the face information of the current user, uploads the face information to the cloud server 30, and the cloud server 30 verifies whether the face information matches the registered face information belonging to the intelligent signature pen 10. If it matches, the user is allowed to use the intelligent signature pen 10. In this embodiment, the intelligent mobile terminal 20 is used for verifying the user's identity to ensure that the user has the right to use the intelligent signature pen 10 and prevent the intelligent signature pen 10 from being illegally used.

In the on-site signature process verification systems of some embodiments, while obtaining the first image information and the second image information, the intelligent signature pen 10 also obtains the current time and integrates the current time into the first image information and the second image information, so that the first image information and the second image information contain the time information of the signature process they record, which is convenient for the subsequent verification terminal 40 to view and check.

In the on-site signature process verification systems of some embodiments, after the intelligent signature pen 10 transmits the first image information and the second image information to the intelligent mobile terminal 20, the intelligent mobile terminal 20 obtains the current position information and uploads the current position information to the cloud server 30 as the attached information of the first image information and the second image information, so as to facilitate the subsequent verification terminal 40 to view and check.

In the on-site signature process verification systems of some embodiments, after receiving the first image information and the second image information, the cloud server 30 synthesizes the picture information corresponding to the first image information and the second image information into one picture and generates a composite file that simultaneously contains the pictures of the first image information and the second image information. That is to say, when the composite file is opened, the first image information and the second image information can be seen at the same time, which is convenient for users to verify the signature site. It can be understood that when synthesizing the first image information and the second image information, they are synthesized according to the same time, that is, the two pictures at the same moment are synthesized into one picture.

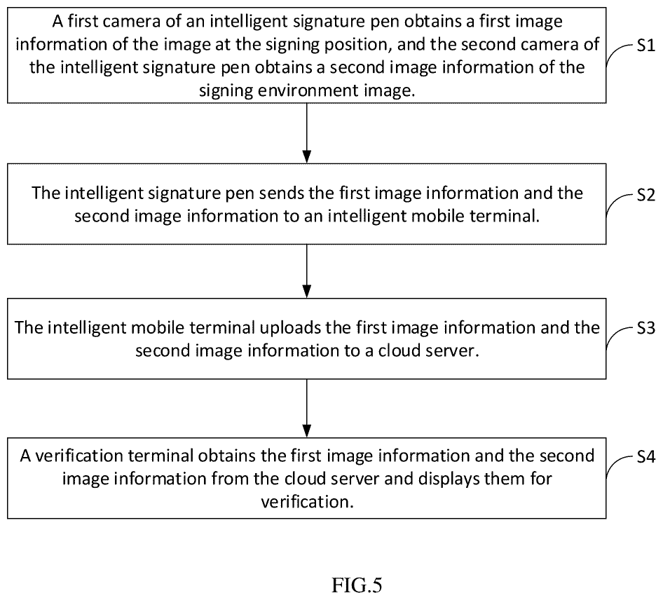

In a preferred embodiment, referring to FIG. 5, this embodiment provides an on-site signature process verification method, which is applied to the on-site signature process verification system in the above embodiments. Specifically, the on-site signature process verification method comprises the following steps:

Step S1: The first camera 102 of an intelligent signature pen 10 obtains a first image information of the image at the signature position, and the second camera 104 of the intelligent signature pen 10 obtains a second image information of signature environment image.

Specifically, the intelligent signature pen 10 includes a first camera 102 located on the pen body 101. The shooting range of the first camera 102 is aligned with the nib part of the intelligent signature pen 10 and is used for obtaining the first image information of the image at the signature position. The image at the signature position refers to an image within a certain range that includes the position where the user signs, so the first image information includes the entire signature process of the user. Optionally, the first image information can be continuous video images or pictures at continuous intervals.

The intelligent signature pen 10 includes a second camera 104 located on the pen cap 103. The shooting range of the second camera 104 is the environment of the signature process and is used for obtaining the second image information of the signature environment image. The signature environment image refers to the surrounding environment information of the signature, such as the signatory, the information of the signature venue, etc., so the second image information includes the environmental information of the environment where the user's entire signature process takes place. Optionally, the second image information can be continuous video images or pictures at continuous intervals.

Step S2: The intelligent signature pen 10 sends the first image information and the second image information to an intelligent mobile terminal 20. After receiving the first image information and the second image information, the intelligent mobile terminal 20 displays a corresponding signature record to facilitate the user to check whether the signature process has been successfully recorded this time. Optionally, the user can also view the first image information and the second image information on the intelligent mobile terminal 20.

Step S3: The intelligent mobile terminal 20 uploads the first image information and the second image information to a cloud server 30. After successfully receiving the first image information and the second image information, the cloud server 30 feeds back the information indicating that the reception is completed to the intelligent mobile terminal 20 to inform the user that the signature process has been successfully uploaded to the cloud server 30 this time.

Step S4: A verification terminal 40 obtains and displays the first image information and the second image information for verification from the cloud server 30. The verification terminal 40 displays the first image information and the second image information for verification, and the verification personnel check whether the first image information and the second image information displayed on the verification terminal 40 are authentic.

In this embodiment, an intelligent signature pen is used to achieve a full record of the signature process, and the signature process can be automatically uploaded to the cloud, enabling remote verification operators to conduct remote verification operations. Compared with the existing technologies, there is no longer a need for complicated equipment and personnel. In this embodiment, only one intelligent signature pen is required, which can reduce labor and hardware costs and improve business efficiency.

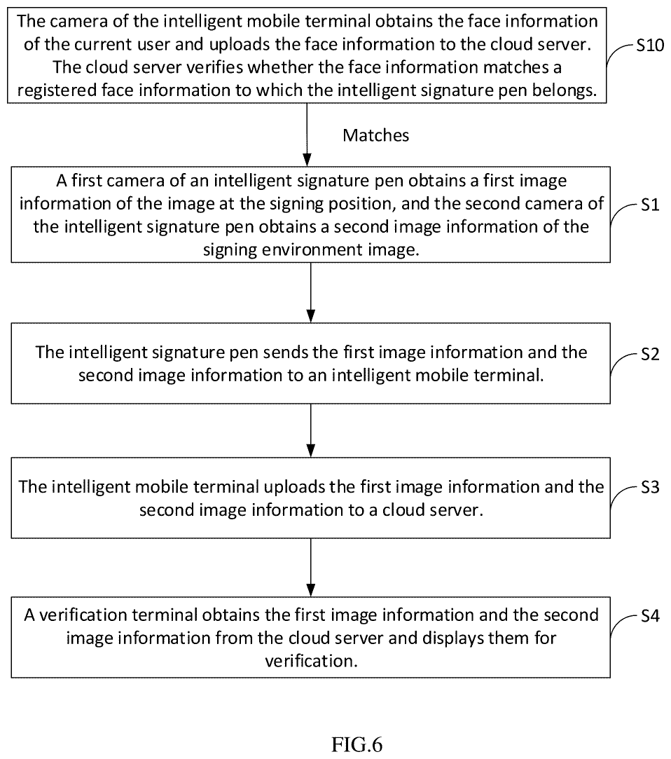

In the on-site signature process verification methods of some embodiments, referring to FIG. 6, this embodiment also comprises the following step before step S1:

Step S10: The camera of the intelligent mobile terminal 20 obtains the face information of the current user, uploads the face information to the cloud server 30, and the cloud server 30 verifies whether the face information matches the registered face information belonging to the intelligent signature pen 10. If it matches, step S1 is executed; if it doesn't match, the user is an illegal user and cannot use the intelligent signature pen 10.

In this embodiment, the intelligent mobile terminal 20 is used to verify the user's identity to ensure that the user has the right to use the intelligent signature pen 10 and prevent the intelligent signature pen 10 from being illegally used.

In the on-site signature process verification methods of some embodiments, step S1 comprising: After the control button 106 of the intelligent signature pen 10 sends out a start recording instruction, the first camera 102 obtains the first image information of the image at the signature position, and at the same time, the second camera 104 obtains the second image information of the signature environment image. After the control button 106 sends out a stop recording instruction, the first camera 102 and the second camera 104 stop recording. In this embodiment, the user controls the start time and end time of recording the signature process through the control button 106, which is convenient for the user to control the recording progress by himself.

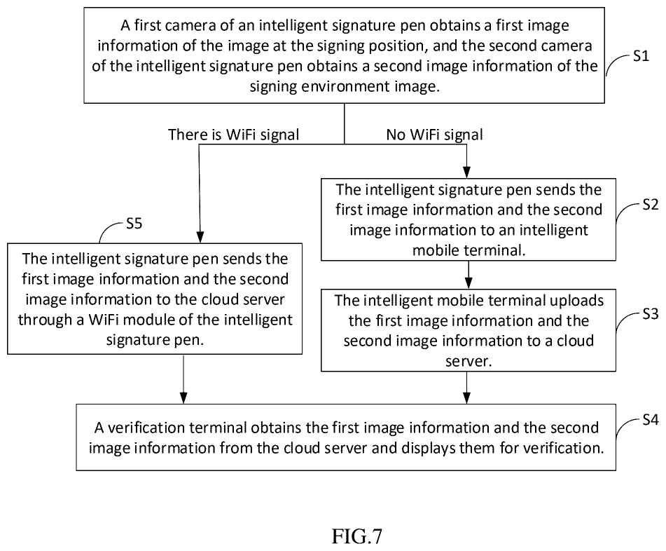

In the on-site signature process verification methods of some embodiments, referring to FIG. 7, the following step is also comprised after step S1:

Step S5: The intelligent signature pen 10 sends the first image information and the second image information to the cloud server 30 through a WiFi module 105 of the intelligent signature pen 10, and then step S4 is executed.

Specifically, when the intelligent signature pen 10 detects that there is an available WiFi signal within its range, it automatically connects to the wireless router. If the wireless router is set with a password, the intelligent mobile terminal 20 can be used to assist the intelligent signature pen 10 to connect to the wireless router. After the intelligent signature pen 10 is connected to the wireless router, the intelligent signature pen 10 uploads the first image information and the second image information to the cloud server 30 through the WiFi module 105.

It should be noted that only after the intelligent signature pen 10 successfully connects to the WiFi signal can the intelligent signature pen 10 send the first image information and the second image information to the cloud server 30 through the WiFi module 105 of the intelligent signature pen 10. If the intelligent signature pen 10 fails to connect to the WiFi signal, then steps S2 and S3 will be executed. That is, when the intelligent signature pen 10 fails to connect to the WiFi signal, it will send the first image information and the second image information to the intelligent mobile terminal 20, and the intelligent mobile terminal 20 will upload the first image information and the second image information to the cloud server 30.

In this embodiment, the intelligent signature pen 10 can directly upload the captured first image information and second image information to the cloud server 30 via the WiFi method, which has a faster transmission rate and can also save the resources of the intelligent mobile terminal 20.

In this specification, each embodiment is described in a progressive manner. The key points described in each embodiment are the differences from other embodiments. For the same or similar parts among the various embodiments, reference can be made to each other. As for the devices disclosed in the embodiments, since they correspond to the methods disclosed in the embodiments, the descriptions are relatively simple, and for the relevant parts, reference can be made to the descriptions in the method part.

Professionals can further realize that the units and algorithm steps of the various examples described in combination with the embodiments disclosed in this document can be implemented by electronic hardware, computer software, or a combination of both. In order to clearly illustrate the interchangeability of hardware and software, the composition and steps of each example have been generally described in terms of functions in the above description. Whether these functions are implemented in hardware or software depends on the specific application and design constraints of the technical solution. Professional technicians can use different methods to implement the described functions for each specific application, but such implementation should not be considered to be beyond the scope of the present invention.

The steps of the methods or algorithms described in combination with the embodiments disclosed in this document can be directly implemented by hardware, software modules executed by a processor, or a combination of both. Software modules can be placed in random access memory (RAM), internal memory, read-only memory (ROM), electrically programmable ROM, electrically erasable programmable ROM, registers, hard disks, removable disks, CD-ROMs, or any other form of storage medium known in the technical field.

The above embodiments are only used to illustrate the technical concept and characteristics of the present invention. Their purpose is to enable those who are familiar with this technology to understand the content of the present invention and implement it accordingly, and they cannot limit the protection scope of the present invention. All equivalent changes and modifications made within the scope of the claims of the present invention shall fall within the coverage scope of the claims of the present invention.

What is claimed is:

1. An on-site signature process verification system, comprising an intelligent signature pen (10), an intelligent mobile terminal (20), a cloud server (30) and a verification terminal (40);
wherein the intelligent signature pen (10) is connected to the intelligent mobile terminal (20) through short-distance wireless communication; the intelligent mobile terminal (20) is connected to the cloud server (30) through a mobile network, and the verification terminal (40) is communicatively connected to the cloud server (30);
the intelligent signature pen (10) includes a first camera (102) located on the pen body (101) and a second camera (104) located on the pen cap (103); the first camera (102) is used for obtaining a first image information of the image at the signing position, and the second camera (104) is used for obtaining a second image information of the signing environment image; the intelligent signature pen (10) sends the first image information and the second image information to the intelligent mobile terminal (20); the intelligent mobile terminal (20) displays the image information during the signing process in real time and uploads the first image information and the second image information to the cloud server (30) after receiving the completion instruction;
the verification terminal (40) obtains the first image information and the second image information from the cloud server (30), and the verification terminal (40) displays the first image information and the second image information for verification.

2. The on-site signature process verification system according to claim 1, wherein the second camera (104) is detachably mounted on the intelligent signature pen (10), and the second camera (104) is connected to the intelligent signature pen (10) through short-distance wireless communication.

3. The on-site signature process verification system according to claim 1, wherein the intelligent signature pen (10) further includes a WiFi module (105), and the intelligent signature pen (10) uploads the first image information and the second image information to the cloud server (30) through the WiFi module (105).

4. The on-site signature process verification system according to claim 1, wherein the intelligent signature pen (10) further includes a control button (106) for controlling the working states of the first camera (102) and the second camera (104).

5. The on-site signature process verification system according to claim 1, wherein an application program for verifying the user's identity is installed on the intelligent mobile terminal (20), and the application program conducts face recognition verification on the current user by calling the camera of the intelligent mobile terminal (20).

6. An on-site signature process verification method, comprising the following steps:
step S1: a first camera (102) of an intelligent signature pen (10) obtains a first image information of the image at the signing position, and a second camera (104) of the intelligent signature pen (10) obtains a second image information of the signing environment image;
step S2: the intelligent signature pen (10) sends the first image information and the second image information to an intelligent mobile terminal (20);
step S3: the intelligent mobile terminal (20) uploads the first image information and the second image information to a cloud server (30);
step S4: a verification terminal (40) obtains the first image information and the second image information from the cloud server (30) and displays them for verification.

7. The on-site signature process verification method according to claim 6, wherein a step is further comprised before step S1:
step S10: the camera of the intelligent mobile terminal (20) obtains the face information of the current user, uploads the face information to the cloud server (30), and the cloud server (30) verifies whether the face information matches a registered face information to which the intelligent signature pen (10) belongs;
if it matches, then execute step S1.

8. The on-site signature process verification method according to claim 6, wherein the step S1 comprising:
after a control button (106) of the intelligent signature pen (10) sends a start recording instruction, the first camera (102) obtains the first image information of the image at the signing position, and at the same time, the second camera (104) obtains the second image information of the signing environment image;
after the control button (106) sends a stop recording instruction, the first camera (102) and the second camera (104) stop recording.

9. The on-site signature process verification method according to claim 6, wherein after the step S1, the following step is also comprised:
step S5: the intelligent signature pen (10) sends the first image information and the second image information to the cloud server (30) through a WiFi module (105) of the intelligent signature pen (10), and then step the S4 is executed.

10. The on-site signature process verification method according to claim 6, wherein the step S2 further comprising:
after receiving the first image information and the second image information, the intelligent mobile terminal (20) displays a corresponding signature record.
